(19) United States
(12) Patent Application Publication
(10) Pub. No.: US 2015/0347403 A1
(43) Pub. Date: Dec. 3, 2015

(54) GESTURE CONTROLLED CONTENT SUMMARIZATION FOR A COMPUTING DEVICE

(71) Applicant: Kobo Inc., Toronto (CA)

(72) Inventor: Robert MacArthur, Milton (CA)

(73) Assignee: Kobo Inc., Toronto (CA)

(21) Appl. No.: 14/294,828

(22) Filed: Jun. 3, 2014

(51) Int. Cl. G06F 17/30; G06F 17/27; G06F 3/0488

(52) U.S. Cl. CPC G06F 17/30011; G06F 3/04883; G06F 17/27

(57) ABSTRACT

A computing device operates to detect a gesture input while displaying text content. The gesture input is interpreted as correlating to a summarization command. A summary of the text content is displayed based on the summarization command.

### TECHNICAL FIELD

Examples described herein relate to gesture controlled content summarization for a computing device.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates an example system for operating a computing device to display text content and summarizations, according to an embodiment.

FIG. 2 illustrates an example of an e-reader device or other electronic personal display device, for use with one or more embodiments described herein.

FIG. 3 illustrates an example e-reader device system for providing summarizations of e-book content, according to an embodiment.

FIG. 4 illustrates an example method for using gesture input to output summarizations of text-based content, according to an embodiment.

FIG. 5A through FIG. 5D illustrate examples for utilizing gesture input to display summarizations of text-based content, according to one or more embodiments.

### DETAILED DESCRIPTION

Examples described herein provide for a computing device that is responsive to gesture input in order to display a summary of a text-based content (such as an e-book). In one aspect, a computing device is provided that can generated a summary of a portion of an e-book in response to a designated gesture input from a user. Still further, examples provide for different kinds of summarizations to be available for display at the selection of the user, depending on the characteristics of the gesture input. For example, the computing device can output a page summary, chapter summary, or book summary, depending on one or more characteristics of the gesture input provided by the user.

According to one aspect, a computing device operates to detect a gesture input while displaying text content. The gesture input is interpreted as correlating to a summarization command. A summary of the text content is displayed based on the summarization command.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

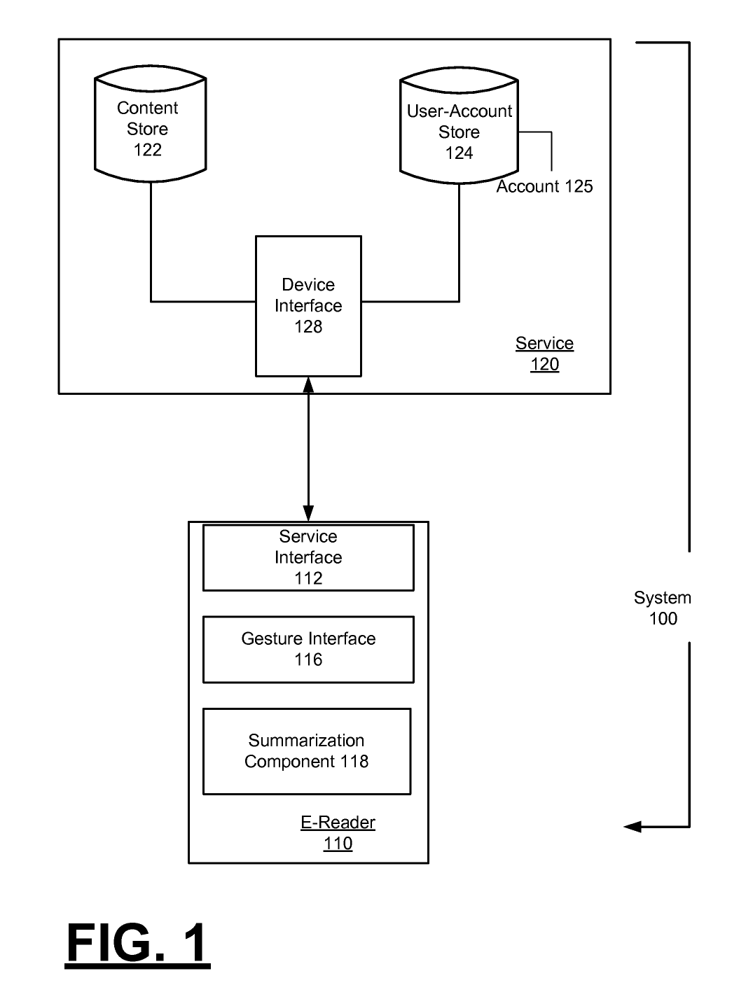

FIG. 1 illustrates an example system for operating a computing device to display text content and summarizations, according to an embodiment. In an example of FIG. 1, system 100 includes an electronic display device, shown by way of example as an e-reader device 110, and a network service 120. The network service 120 may include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to FIG. 1, the e-reader device 110 includes a service interface 112, a gesture interface 116, and a summarization component 118. The service interface 112 can communicate with the network service 120 in order to receive services, content (e.g., e-books) account information and updates, and/or other network services open (e.g., archiving). The gesture interface 116 can interpret user contact with a touch sensitive region or portion of the e-reader device 110. In one implementation, the gesture interface 116 interprets a user contact or physical interaction with the display screen of the e-reader device 110 as a command.

The summarization component 118 generates or otherwise displays summarizations of displayed text content. In one implementation, the summarization component 118 generates one or more kinds of summarizations for text-based content that is being displayed on the e-reader device. Each summary can be displayed on at least a portion of the display screen, utilizing some of the content provided with the e-book. In this regard, the summary provided by the summarization component 118 can be a derivative work or abstract of text-based content provided on the e-reader device 110. In one implementation, the text-based content can correspond to e-book, such as a novel, nonfiction book or other literary work. The summarization component 118 can be responsive to commands, including one or more commands interpreted by the gesture interface 116.

Still further, the summarization component 118 can provide different kinds of summarizations. In the context of e-books, the summarization component 118 can generate a page summary, chapter summary or book summary. The page summary can, for example, be displayed on the e-reader device 110 to summarize the contents of a displayed page of the e-book, using fewer words and/or alternative formatting for easier reading. Further, the chapter summary can, for example, display summary of a chapter of the e-book, while the book summary can display a summary of the entire book.

According to one aspect, the summarization component 118 can programmatically generate each type of summarization. For example, the summarization component 128 can programmatically scan a page, chapter or entire book in response to user gesture input, and then generate one or more summarizations based on different rules. By way of example, summarizations can be generated using logic and rules such as, for example, using the first sentences of individual paragraphs, abbreviating or deleting certain words from summary statements, and prioritizing certain sentences (first sentence of each chapter, etc.). In a variation, one or more of the different kinds of summarizations can be pre-stored on the e-reader device 110 and then displayed on a display screen of the e-reader device by the summarization component 118 in response to gesture input from the user.

In one implementation, the gesture interface 116 detects a particular gesture input from a user, and then interprets the gesture input as a command. The command can be utilized by the summarization component 118 to select a type of summarization, which is then displayed on the e-reader device 110. In this way, the user can provide a gesture input via the gesture interface 116 in order to select a type of summary for display.

Hardware Description

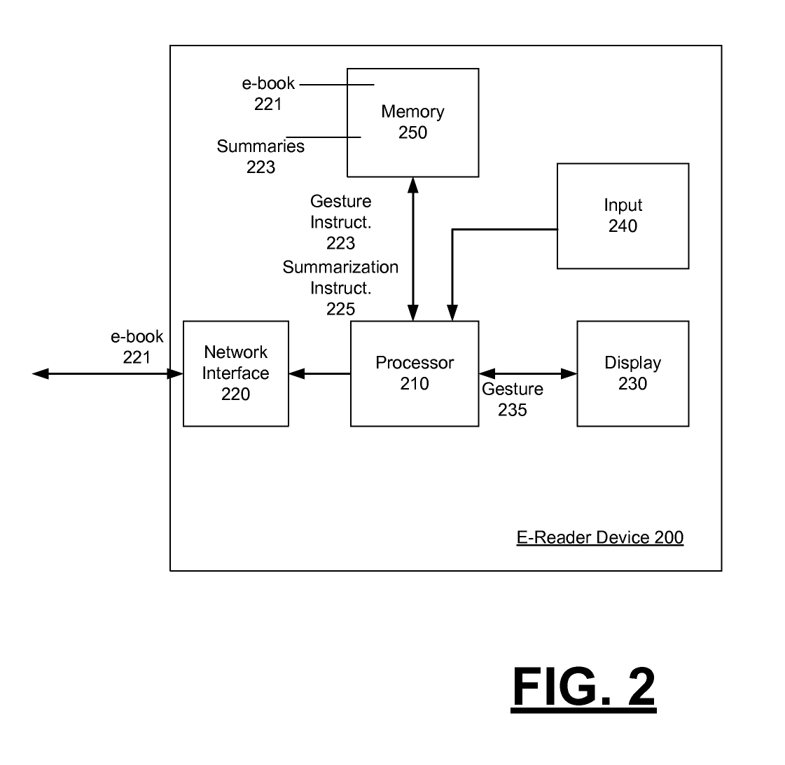

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which conventional paper displays content. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices).

According to some embodiments, the memory 250 stores instructions 223 for providing the gesture interface 116 (see FIG. 1), and instructions 225 for providing the summarization component 118 (see FIG. 1). In one example, the processor 210 receives a gesture input 235 detected through a user's physical interaction with a touch-sensitive surface of the display 230. The processor 210 executes the gesture interface instructions 223 to interpret the gesture input 235. In one implementation, the gesture input 235 can be interpreted as one of multiple possible commands, and more specifically, as one of multiple possible summarization commands. The processor 210 can execute the summarization instructions 225 in order to generate or otherwise display, via the display 230, a summary that is of a type selected by the summarization command, as interpreted from gesture input 235.

E-Reader Device System

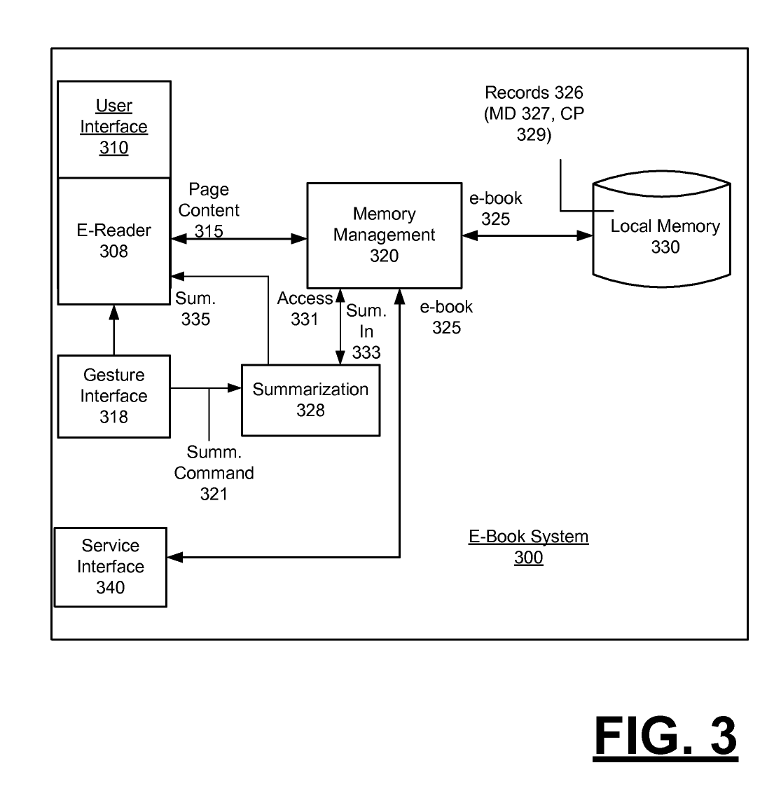

FIG. 3 illustrates an e-reader device system for providing summarizations of e-book content, according to an embodiment. In reference to FIG. 3, a system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the users account when the user purchases a new e-book from the service. Each e-book can correspond to a literary work having a pagination format. Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. Alternatively, as another example, network service 120 can be configured to push e-books to the e-reader device 110 of system 300, based on, for example, user account settings, subscription plans and rules, and various other business logic considerations.

Still further, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of individual e-books for purpose of rendering e-books via the user interface 310.

In one example, the user interface 310 includes an e-reader component 308 which displays paginated content 315 corresponding to a portion of an e-book. The e-reader component 308 can also be responsive to certain kinds of input, including page transition input. The page transition input can cause the e-reader component 308 to transition pages individually, by cluster, and/or by chapter.

In one implementation, a gesture interface 318 is integrated or otherwise provided with the e-reader component 308. The gesture interface 318 can be provided by, for example, a processor 210 (see FIG. 2) executing the gesture interface instructions 223. The gesture interface 318 can interpret different kinds of gesture input from the user. In one implementation, the gesture interface 318 interprets a summarization command 321. The summarization command 321 can be communicated to a summarization component 328. In response to receiving the summarization command 321, summarization component 328 outputs a summary 335 via the e-reader component 308. The summary 335 can replace some or all of the page content 315 that is displayed by the e-reader component 308.

In one implementation, summary 335 can correspond to one of a page summary, chapter summary, or book summary. The summarization component 328 may select a particular kind of summary 335 based on the summarization command 321. More specifically, one implementation provides for gesture interface 318 to generate one of multiple possible summarization commands, each of which correspond to different kind of summary. The particular summary 335 that is selected by the summarization component 328 can be determined from the summarization command 321, which in turn is based on the interpretation of the gesture input by gesture interface 318.

In one implementation, the summarization component 328 generates the summary 335 in response to receiving the summarization command 321. Various kind of logic can be utilized to generate summary of different kinds. Page summarizations, for example, can be generated on-the-fly by programmatically scanning paragraphs and sentences provided on a page, and using rules or other logic to select portions of sentences as part of the summarizations. For example, the summarization component 328 can utilize the first and last sentence of each paragraph on a particular page (as displayed through the e-reader component 308) to formulate at least a portion of a page summary. Additionally, a chapter summary can be generated using, for example, the first sentence of every other paragraph, with words parsed and analyzed to identify significant words or terms. Likewise, a book summary can be based on the opening paragraphs of individual chapters. In a variation, the summarization component 328 uses pre-canned or predetermined summarizations. For example, a book summary can be generated substantially from a publisher summary as provided on a cover or “jacket” of the e-book. In such an example, the book summary can be maintained in the local memory 330, as part of, for example, the record 326 for the e-book that is in use and being rendered via the e-reader component 308.

In one implementation, the summarization component 328 can access 331 local memory 330 in order to receive summary input 333, corresponding to, for example, text or sentences for individual pages, chapter or book summarizations. Still further, in an example of FIG. 1, the summarization component 328 can access the local memory 330 to obtain one or more summarizations via the memory management module 320. Some or all of the summarizations can be stored on the device when, for example, the e-book that is in use is downloaded.

As an alternative or variation, the summarization component 328 can retrieve some or all of the summarizations that are requested (or may be requested) from a network resource, such as from network service 120 (see FIG. 1). By way of example, network service 120 can maintain page, chapter or book summarizations for different titles, and the network service 120 may provide the summarizations to a particular e-reader device on request. The summarization component 328 can communicate with the network service via service interface 340 in order to identify the e-book, the type of summary needed, and the page or chapter if applicable for which the summary is to cover. The summarization component 328 can receive the summary from the network service 120 via the service interface 340.

According to one aspect, when the e-reader component 308 displays a given summary 335, the gesture interface 318 can continue to interpret either an existing gesture input or a new gesture input from the user. Such an additional gesture input can be used to change the selected summary that is on display. For example, a user may provide a first gesture input that is interpreted by the gesture interface 318 as a first summarization command 321. The summarization component 328 can output a first type of summary 335 in response to the first gesture input. The first type of summary 335 can correspond to, for example, a page summary. Once displayed on the device of the e-reader via the e-reader component 308, the user may continue a previous contact, or alternatively initiate a new contact, that is interpreted as an additional or second gesture input by the gesture interface 318. A second summarization command 321 can be communicated to the summarization component 328 in response to the subsequent contact.

In response to receiving the second summarization command 321, the summarization component 328 generates a second type of summary 335 for output on the display device via the e-reader component 308. In this way, the user can transition from one type of summary to the next using gesture input. Furthermore, the transition from one type of summary to the next can be done while summary content is displayed on the e-reader device (in place of page content 315) via the e-reader component 308.

Methodology

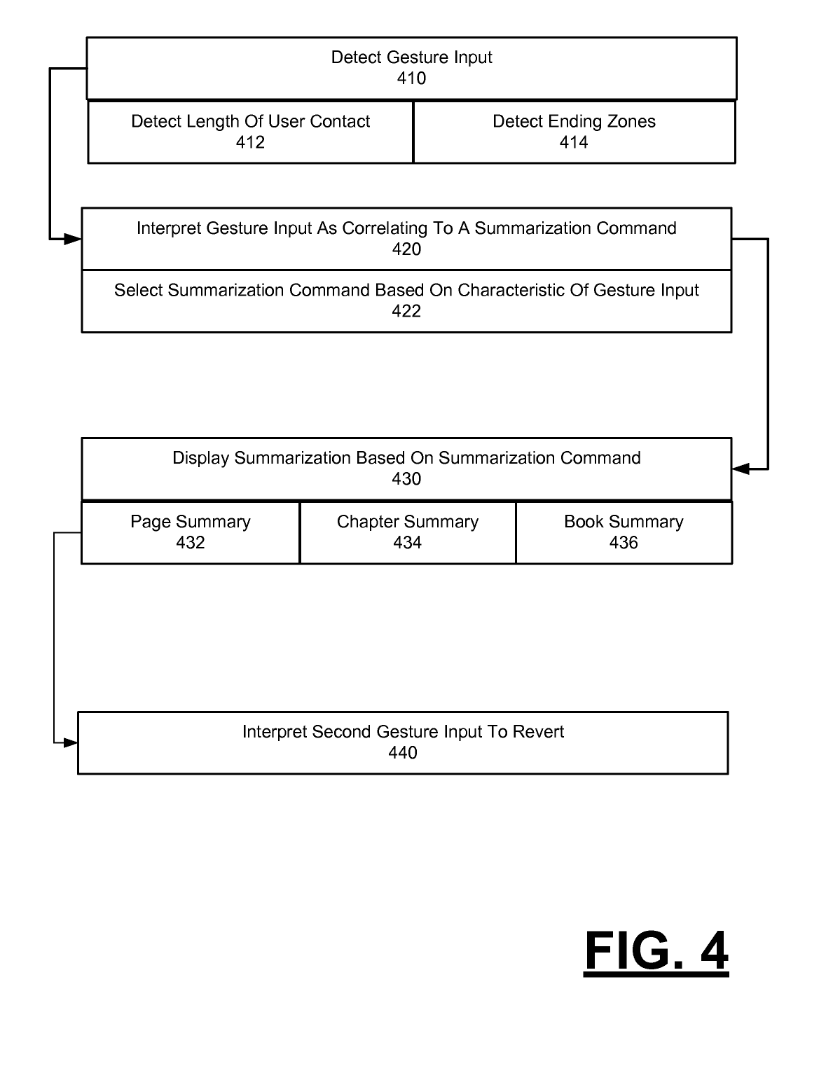

FIG. 4 illustrates an example method for using gesture input to generate summarizations of text-based content. A method such as described by an example of FIG. 4 can be implemented using, for example a system such as described with an example of FIG. 1, an e-reader device such as described with an example of FIG. 2, and/or an e-reader system such as described with an example of FIG. 3. Accordingly, reference may be made to elements of other figures for purpose of illustrating a suitable component for performing a step or sub-step being described.

With reference to FIG. 4, an e-reader device interprets the gesture input (410). In one implementation, the gesture input is received on a touch sensitive display screen of an e-reader device. The gesture input can correspond to, for example, a multi-touch input. In one implementation, the gesture input can correspond to a multi-touch input that accompanies a movement and/or a placement. The gesture input can further include characteristics that trigger, or are otherwise characteristic of a particular type of command. In this way, the gesture input can specify one summarization command from multiple possible other commands, including one summarization command from one or more other summarization commands. In one implementation, the gesture input corresponds to mufti-touch input (e.g., two fingers placed on the display screen at the same time), having one or more characteristics such as (i) a starting point (e.g., right region of display screen), (ii) motion or movement (e.g., moving from right to left), and/or (iii) an ending point (e.g., a particular region on the display screen). The characteristics of the gesture input can distinguish the desired input from other gesture inputs, and further enable selection of one summarization command over other summarization commands.

Accordingly, one or more characteristics can be detected from the gesture input. For example, a length of the user contact corresponding to the gesture may be detected by a combination of the processor and sensors of the device (412). As another example, an ending zone or region where the user contact terminates being in touch contact with the display screen of the device may also be detected as a characteristic of the gesture input (414).

The gesture input can be correlated to a summarization command (420). In particular, the summarization command can be selected or determined from the detected characteristics of the gesture input (422), such as the spatial or temporal length of the user-contact with the display screen and/or the ending region or zone of the user contact with the display screen.

The e-reader device 110 can displays a summarization of text-based content in use on the e-reader device 110 when the gesture input is received (430). In one implementation, multiple types of summarizations can be generated depending on the gesture input and the interpreted summarization command. In particular, the type of summarization can correspond to a page summary (432), a chapter summary (434), and/or a book summary (436). In one implementation, two different types of summarizations may be available (e.g., page and book summarizations) for selection based on gesture input, while in variations three or more types of summarizations (e.g., page, chapter, and book summarizations) may be available for selection based on gesture input.

In one implementation, the e-reader device 110 displays a summarization of a selected type in place of text-based content for the e-book that is in use. For example, a summary page may be rendered and displayed in place of the text-based content. Alternatively, the text-based content can be provided as an overlay, or in a window or region that occupies a portion of the overall display when the text-based content is rendered.

In one implementation, when the summary is displayed, a mechanism is provided to enable the user to revert the display screen to displaying the text-based content of the e-book. In particular, a second gesture may be detected and interpreted in order to cause the e-reader device 110 to revert to displaying the text-based content of the e-book that is in use (440).

### EXAMPLES

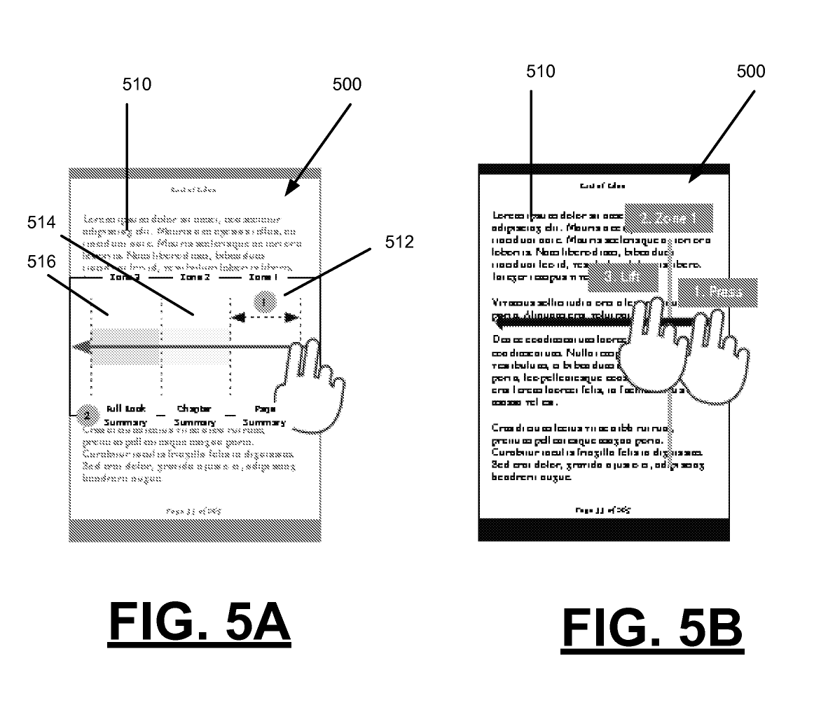

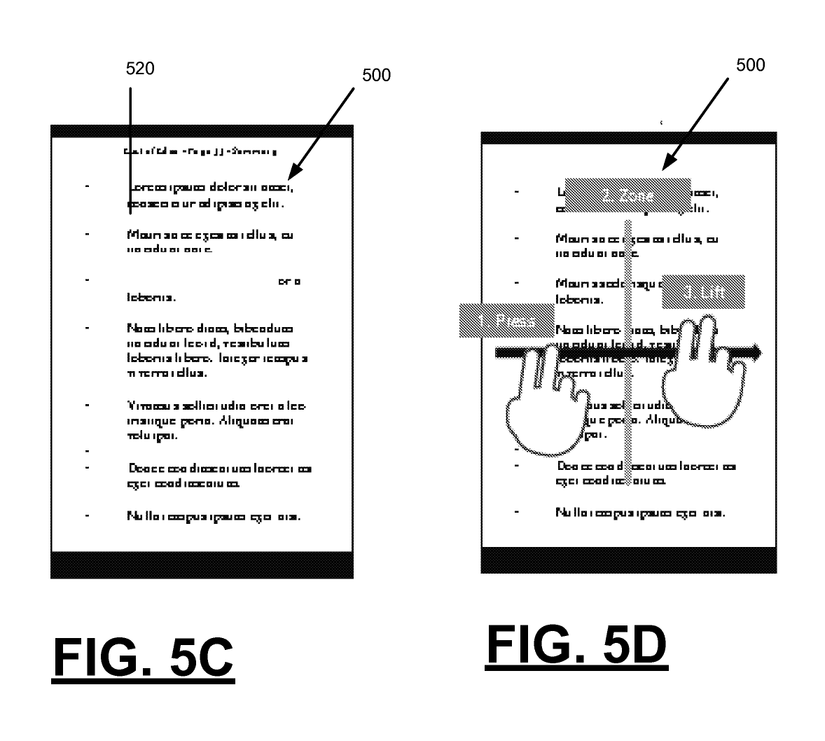

FIG. 5A through FIG. 5D illustrate examples for utilizing gesture input to display summarizations of text-based content, according to one or more embodiments. Examples such as described by FIG. 5A through FIG. 5D can be implemented using, for example, elements such as described with prior examples, including with system such as provided with an example of FIG. 1, an e-reader device such as provided with an example of FIG. 2 or an e-reader device system of FIG. 3.

With reference to an example of FIG. 5A and FIG. 5B, a display screen 500 of an e-reader device includes text-based content 510 provided from, for example, an e-book. With reference to FIG. 1, the gesture interface 116 and the summarization component 118 can combine to define multiple regions on the display screen 500. A particular user gesture input of a right to left swipe can be provided with the characteristic of an ending region, and the characteristic (the region where the gesture ends) can be used to select one type of summarization command over one or more other summarization commands. For example, with reference to FIG. 5A, if the user gesture ends in region 512, an interpretation of the gesture input may correspond to a summarization command to generate or display a page summary. If the user gesture ends in region 514, an interpretation of the gesture input may correspond to a summarization command to generate or display a chapter summary. Similarly, if the user gesture ends in region 516, an interpretation of the gesture input may correspond to a summarization command to generate or display a book summary.

FIG. 5B illustrates an implementation of how the gesture ending region shown by an example of FIG. 5A can be provided. The display content 510 may be provided, with the regions 512, 514, 516 being hit in their otherwise invisible to user. A user gesture may begin at the starting point (e.g., right edge of display screen 500, or alternatively right and center of edge of display screen) and end at one of multiple pre-defined ending regions or zones. As shown with an example of FIG. 5A, the particular region or zone where the gesture ends (e.g., the user lifts the fingers or otherwise ends the contact with the display screen 500) defines the summarization command and the resulting type of summary that is displayed to the user on the display screen 500.

FIG. 5C illustrates an example of a summary 520 that can be outputted by summarization component. In the example provided, summary 520 represents a page summary. Further, the page summary 520 can replace the text-based content 510 that was provided on the display screen 500.

In one implementation, when a particular type of summary is displayed on the display screen 500, the particular region or zone where the gesture input for creating that type of summary is made inactive. Thus, when the page summary is displayed, subsequent user contact on where the endpoint is in the region 512 may be inactive or non-responsive. However, in one example, the user can initiate a new gesture on the display screen 500 when the summary 520 is provided. As an alternative or variation, the user can continue the existing gesture (e.g., the user never lifts his fingers off the display screen 500 when the summary 520 is created). The new or continued gesture can extend into another one of the regions 514, 516 in order to generate a new summarization command for generating a different type (e.g., chapter summary, book summary) of summary from the text-based content.

FIG. 5D illustrates an example of a second type of gesture input that can revert the e-reader device to display the text-based content on the display screen 500. In particular, once the summary 520 occupies a display screen, another gesture input can be used to revert the display screen 500 displaying the text-based content. In the example shown, the second gesture input can correspond to the user providing a two finger swipe from right to left on the display screen 500 when the summary 520 is displayed.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
detecting a gesture input while displaying text content;
interpreting the gesture input as correlating to a summarization command; and
displaying a summary of the text content based on the summarization command.

2. The method of claim 1, wherein interpreting the gesture input includes selecting one of multiple possible summarization commands as correlating to the gesture input based on one or more characteristics of the gesture input.

3. The method of claim 2, wherein displaying the summary of the text content includes selecting one of a page summary, chapter summary, or book summary based on the selected summarization command.

4. The method of claim 2, wherein the one or more characteristics of the gesture input includes a length of a user contact with a display screen of the computing device.

5. The method of claim 2, wherein the one or more characteristics of the gesture input includes a starting point and an ending point of a user contact with a display screen of the computing device.

6. The method of claim 5, further comprising determining that the ending point of the user contact is in one of multiple zones, wherein each zone of the multiple zones corresponds to a particular summarization command.

7. The method of claim 6, further comprising:
in response to determining that the ending point of the user contact is in a first zone of the multiple zones, interpreting the gesture from the user contact as a first summarization command, and then displaying a first summary based on the first summarization command; and
while displaying the first summary, detecting an ending point of a second user contact being in a second zone of the multiple zones, interpreting a second gesture from the second user contact as a second summarization command, and then displaying a second summary based on the second summarization command.

8. The method of claim 1, wherein displaying the summary of the text content includes replacing the text content on a display area of the computing device with the summary.

9. The method of claim 8, further comprising:
detecting a second gesture input while displaying the summary;
reverting to displaying the text content in response to detecting the second gesture input.

10. A computing device comprising:
a memory that stores a set of instructions;
a display screen;
one or more processors that execute the instructions stored in the memory to:
interpret a gesture input received while displaying text content as correlating to a summarization command; and
displaying a summary of the text content based on the summarization command.

11. The computing device of claim 10, wherein the one or more processors interpret the gesture input by selecting one of multiple possible summarization commands as correlating to the gesture input based on one or more characteristics of the gesture input.

12. The computing device of claim 11, wherein the one or more processors display the summary of the text content by selecting one of a page summary, chapter summary, or book summary based on the selected summarization command.

13. The computing device of claim 11, wherein the one or more characteristics of the gesture input includes a length of a user contact with the display screen of the computing device.

14. The computing device of claim 11, wherein the one or more characteristics of the gesture input includes a starting point and an ending point of a user contact with the display screen of the computing device.

15. The computing device of claim 14, wherein the one or more processors execute the instructions stored in memory to determine that the ending point of the user contact is in one of multiple zones, each zone of the multiple zones corresponding to a particular summarization command.

16. The computing device of claim 15, wherein the one or more processors execute the instructions stored in memory to:
in response to determining that the ending point of the user contact is in a first zone of the multiple zones, interpret the gesture from the user contact as a first summarization command, and then display a first summary based on the first summarization command; and
while displaying the first summary, detect an ending point of a second user contact being in a second zone of the multiple zones, interpret a second gesture from the second user contact as a second summarization command, and then display a second summary based on the second summarization command.

17. The computing device of claim 10, wherein the one or more processors display the summary of the text content by replacing the text content on a display area of the computing device with the summary.

18. The computing device of claim 17, wherein the one or more processors execute the instructions stored in memory to:
detect a second gesture input while displaying the summary;
revert to displaying the text content in response to detecting the second gesture input.

19. The computing device of claim 10, wherein the one or more processors generate the summary in response to interpreting the gesture.

20. A computer-readable medium that stores instructions, which when executed by one or more processors of a computing device, cause the computing to perform operations that comprise:
detecting a gesture input while displaying text content;
interpreting the gesture input as correlating to a summarization command; and
displaying a summary of the text content based on the summarization command.
